(19) United States
(12) Patent Application Publication
(10) Pub. No.: US 2025/0283828 A1
(43) Pub. Date: Sep. 11, 2025

(54) SPARK STAND FOR OPTICAL EMISSION SPECTROMETRY WITH IMPROVED DUST REMOVAL

(71) Applicant: Thermo Fisher Scientific (Ecublens) SARL, Ecublens (CH)

(72) Inventors: Patrick Lancuba, Ecublens (CH); Aurelien Clerc, Ecublens (CH)

(73) Assignee: Thermo Fisher Scientific (Ecublens) SARL, Ecublens (CH)

(21) Appl. No.: 18/859,964

(22) PCT Filed: Apr. 12, 2023
(86) PCT No.: PCT/EP2023/059599

§ 371 Date: Oct. 24, 2024

(30) Foreign Application Priority Data
Apr. 25, 2022 (GB) 2206014.9

(51) Int. Cl. G01N 21/67

(52) U.S. Cl. CPC G01N 21/67

(57) ABSTRACT

A spark stand for an optical emission spectrometer, comprising: a spark chamber; and at least one auxiliary gas conduit for providing an auxiliary gas flow into the spark chamber, wherein the at least one auxiliary gas conduit is configured to provide the auxiliary gas flow into the spark chamber for a period after spark operation but not during spark operation in which analysis of a sample takes place. The auxiliary gas flow into the spark chamber improves flushing of dust from the spark chamber after spark operation.

### FIELD

This disclosure relates to the field of spark optical emission spectrometry. In particular, the disclosure is concerned with an improved spark stand for an optical emission spectrometer, an optical emission spectrometer comprising the same and a method of optical emission spectrometry.

### BACKGROUND

Arc/spark optical emission spectrometry is a well-known technique used to analyse solid, typically metallic, samples. Optical emission spectrometry may be conducted with either a spark source or arc source or both. For convenience, as used herein, the term spark optical emission spectrometry means any optical emission spectrometry employing an electrical discharge to excite the sample such as a spark or arc for example, and the term spark chamber means a space or volume for conducting such electrical discharge from which light is emitted and measured.

During use, a conductive (typically metallic) solid sample is mounted onto a spark stand over an aperture leading to the spark chamber, wherein the sample is usually flat so that it makes a gas-tight seal with the stand. Within the spark chamber is positioned an electrode, usually to act as an anode, that is oriented to present a tapered end towards the sample. The electrode is surrounded by an electrical insulator, except for its tapered end. A sequence of electrical discharges is initiated between the electrode and the sample, in which the sample acts as a cathode. The insulator promotes discharge to the sample rather than the chamber wall. Sample material local to the discharges is ablated/vaporised and a proportion of the ablated/vaporised material is raised to excited states. On relaxing, the ablated and excited material emits photons, the energies (wavelengths) of which are characteristic of the given state transitions of elements in the material. Spectroscopic analysis of the emitted photons enables the composition of the sample material to be deduced. A proportion of the light emission caused by the discharges is therefore transmitted from the spark chamber to the analyser for spectroscopic analysis. The spectroscopic analysis is conducted using an optical analyser, which typically utilises a dispersive means such as a grating to disperse light spatially according to its wavelength. The analyser comprises an optical detector, such as an array detector for example, to measure the quantity of light as a function of the wavelength in order to obtain an emission spectrum.

To obtain information about a wide range of elements within samples, the instrument should be capable of transmitting photons below 200 nm from the spark chamber to the detector, as some elements emit photons in the vacuum ultraviolet (VUV) wavelength range when relaxing to a lower energy state. To avoid absorption of these VUV photons by air and to avoid wavelength shifts associated with changes in the refractive index of gases (which changes with the pressure of the gas and the gas composition), the sample material is excited in the presence of a substantially UV transparent and inert gas, typically argon, which is fed into the spark chamber at least during the time when the sequence of spark discharges is initiated. Once the gas composition is maintained constant in the spectrograph, the problem of refractive index shift is removed and the light detection is able to take place in steady-state conditions.

A problem is that atoms, aggregates or particles of ablated material, herein referred to as debris or dust, from the sample surface can persist in the chamber and/or re-precipitate and may affect later measurements. To prevent cross contamination or so-called memory effects, preferably all the ablated material from one analysed sample should be removed from the spark chamber before analysis of the next sample to eliminate any re-deposition of material from the preceding sample onto the next sample and to prevent any such material from being present in the path of the electrical discharges. The flowing gas through the spark chamber is utilised to sweep ablated materials, including metallic dust or debris, from the spark chamber in a continuous or semi-continuous process. In this way, much of the ablated material is carried away from the spark chamber in the flow of gas to a filter downstream.

One particular design of spark chamber employing a flow of gas is disclosed in WO 2012/028484 A1 (Thermo Fisher Scientific). However, dust is not completely removed and, over time, ablated sample material can still deposit and build-up on the insulator, as well as on other surfaces within the spark chamber and along gas conduits. This leads to deterioration of the analytical performances of the spectrometer and, when this occurs, the spectrometer can't be used whilst the spark chamber is cleaned, or while some components are substituted, which increases the costs of maintenance and the amount of instrument downtime.

One method to address to prevent dust accumulation over multiple analysis cycles is to use a strong gaseous flush sequence through the spark chamber, which takes place at the end of each spark-analysis sequence. However, the direction of the strong gaseous flush is the same as the flush used during the spark-analysis and for some chamber designs, such as disclosed in WO 2012/028484 A1, it remains a largely laminar flow. This is not very efficient for dust removal from the chamber.

In view of the above, this disclosure is presented.

### SUMMARY

According to an aspect of the present disclosure there is provided a spark stand for an optical emission spectrometer, comprising: a spark chamber; and at least one auxiliary gas conduit for providing an auxiliary gas flow into the spark chamber, wherein the at least one auxiliary gas conduit is configured to provide the auxiliary gas flow into the spark chamber for a period after spark operation but not during spark operation.

The analysis of a sample takes place during a spark operation. The auxiliary gas flow into the spark chamber improves flushing of dust from the spark chamber after spark operation. In this way, dust is removed from the spark chamber after a sample analysis and before the next analysis is performed. The term dust herein refers to any matter derived from the ablation of material by the spark operation, for example ablation of material from a solid surface of a sample. The period for which the at least one auxiliary gas conduit provides the auxiliary gas flow into the spark chamber is sufficient to allow removal of at least some, preferably most, of the dust caused by spark operation. The period for flushing dust from the spark chamber by means of the auxiliary gas flow may be implemented after every spark operation and/or after a plurality of spark operations, for example periodically and/or after a set number of spark operations has occurred. The period for flushing dust from the spark chamber by means of the auxiliary gas flow may be implemented after each spark operation and before each spark operation. Thus, in such embodiments, there can be two flushing periods between each spark operation (analysis period). The period for flushing dust from the spark chamber by means of the auxiliary gas flow may be, for example, from 1 to 5 seconds, such as about 2 seconds, or 3 seconds, or 4 seconds. The auxiliary gas flow may be a continuous flow during the period or, preferably, may comprise a sequence of short gas bursts or pulses, which may further improve dust removal. For example, each short gas burst or pulse may last less than 1 second (e.g. 0.1 to 0.9 seconds, or 0.1 to 0.5 seconds, or shorter e.g. milliseconds or tens of milliseconds), such as a few tenths of a second (e.g. 2/10 ths, 3/10 ths, 4/10 ths, 5/10 ths, 6/10 ths, 7/10 ths, or 8/10 ths of a second). This period for flushing contrasts with the duration of a typical spark operation or analysis phase that may last, for example, from 5 to 50 s, or 10 to 25 s, which is usually made up of 2 to 3 phases of 4 to 8 seconds of sparks (so that the total sparking period is, e.g., between 10 to 25 s).

In some embodiments, the at least one auxiliary gas conduit is a single auxiliary gas conduit. In some embodiments, the at least one auxiliary gas conduit is two or more auxiliary gas conduits, for example three or four, or more auxiliary gas conduits.

In some embodiments, the at least one auxiliary gas conduit is switchable between an open position and a closed position, i.e. an open position allowing gas flow into the spark chamber and a closed position preventing gas flow into the spark chamber. The at least one auxiliary gas conduit is thus arranged to be in the closed position during spark operation and in the open position for the period (after spark operation) when flushing debris from the spark chamber. At other times, the at least one auxiliary gas conduit may be arranged to be in the closed position, for example when not flushing the spark chamber

In some embodiments, the at least one auxiliary gas conduit comprises at least one valve to open or close the at least one auxiliary gas conduit and thereby allow or prevent the auxiliary gas flow into the spark chamber. For example, the valve may be shut during spark operation to prevent the auxiliary gas flow into the spark chamber. The valve may be opened after spark operation to allow the auxiliary gas flow into the spark chamber. A controller may be provided and configured to control the gas flows as described in this disclosure. The at least one valve may be controlled by the controller, which preferably also controls the spark operation. The controller may comprise a processor, or control logic such as a state machine, and associated control electronics for controlling the valve(s) and/or spark operation (e.g. voltage source, spark frequency, total spark duration etc.).

In some embodiments, the spark stand, further comprises: a first gas conduit for providing a first gas flow into the spark chamber at least during spark operation. The spark stand may further comprise a second gas conduit for carrying gas from the spark chamber. The first and second gas conduits may be positioned diametrically opposite each other on either side of the spark chamber. The second gas conduit may be connected to an exhaust or waste line, optionally including a debris and dust filter, or connected to a gas recycling line, which may filter the gas to remove debris and dust before returning the gas to the first and/or auxiliary gas conduits. In some embodiments, the first gas conduit is for providing the first gas flow into the spark chamber after spark operation additionally to during spark operation such that the auxiliary gas flow combines with the first gas flow after spark operation. It is beneficial to continue to provide the first gas flow into the spark chamber from the first gas conduit while the auxiliary gas flow is provided into the spark chamber as this can prevent any dust travelling back up the first gas conduit, which may lead to the optical system (spectrograph).

In some embodiments, the at least one auxiliary gas conduit is configured to provide the auxiliary gas flow in a crossed flow configuration with the first gas flow. The crossed flow configuration can enable the generation of gas turbulences in the spark chamber, preferably in the vicinity where the spark is generated. If the first gas flow is arranged as an axial flow through the spark chamber along an axis from the first (inlet) conduit to the diametrically positioned second (outlet) conduit, the at least one auxiliary gas conduit is configured to provide the auxiliary gas flow in a cross-axial direction, i.e. at a non-zero angle to the axis of the first gas flow.

In some embodiments, the first gas flow is laminar flow. In some embodiments, preferably the first gas flow is laminar flow during spark operation and the laminar flow is broken by the auxiliary gas flow after spark operation. It is generally beneficial for the auxiliary gas flow to provide a turbulent gas flow in the spark chamber after spark operation.

In some embodiments, the flow rate of the auxiliary gas flow is greater than the flow rate of the first gas flow (at least greater than the first gas flow during the spark operation). For example, the flow rate of the auxiliary gas flow may be at least 2 times or at least 3 times greater than the flow rate of the first gas flow employed during spark operation, for example 3 to 10 times greater or 3 to 5 times greater. In one embodiment, the auxiliary gas flow is about 15 L/min, whereas the first gas flow during analysis is only in the range from 2 or 3 L/min to 5 L/min. The auxiliary gas flow may comprise a series of gas bursts or pulses.

In some embodiments, the at least one auxiliary gas conduit is two auxiliary gas conduits, the two auxiliary gas conduits being positioned symmetrically on either side of the first gas conduit (in a lateral direction). In some embodiments, where the at least one auxiliary gas conduit is a single auxiliary gas conduit, the auxiliary gas conduit is positioned to one side of the first gas conduit (in a lateral direction).

Advantageously, the auxiliary gas flow, especially in embodiments in which it crosses with the first gas flow, allows a laminar flow to be interrupted, particularly in the region surrounding the electrode and the insulator surrounding the electrode. The auxiliary gas flow, and particularly the interruption of the first gas flow by the auxiliary gas flow, can generate gas turbulences and/or unsteady vortices, which may interact with each other and create friction and pressure variation effects. This may stir up accumulated debris and dust, resulting in improved dust removal and reduced dust build-up. In turn, this means less maintenance of the instrument is required. In some embodiments, while the auxiliary gas flow stirs up dust, the first gas flow can act to push dust down the second gas conduit (gas outlet) to an exhaust. In one embodiment, a short delay may be implemented between the operation of the auxiliary gas flow to stir accumulated dust and operation of the first gas flow to push the dust to the outlet of the chamber.

The spark chamber or any of the auxiliary, first or second conduits may comprise an anti-adhesion material on their surface to further reduce deposition of debris or dust. The anti-adhesion material is typically a non-metallic material. The anti-adhesion material is typically a material of low friction coefficient, e.g. having a static and dynamic coefficients of friction of 0.5 or less, or 0.4 or less, or 0.3 or less. Such materials are described in WO2020/200757A1 (Thermo Fisher Scientific).

An elongated electrode having an electrode axis generally along the direction of elongation is located within the spark chamber. In use, there is generally a gas flow, especially a laminar flow, through the spark chamber, for example between the first (inlet) and the second (outlet) gas conduits. Preferably, the wall of the spark chamber, i.e. the radial wall (radially facing the electrode), is curved thereby defining an internal volume of the spark chamber with a curved outer shape, which is preferably cylindrical, i.e. the wall of the spark chamber defines a cylindrical shape. The surface of such wall may comprise an anti-adhesion material as mentioned above. Preferably the spark chamber is substantially cylindrical and the electrode is located approximately on the axis of the cylinder. Preferably the first and second gas conduits are located on the curved internal wall of the cylinder and are on opposing sides of the cylinder, more preferably on substantially diametrically opposing sides. Preferably the first and second gas conduits are diametrically opposed to each other on the spark chamber wall.

The elongated electrode may be of any cross sectional shape (i.e. in cross section transverse to the electrode axis), but is preferably cylindrical in shape with a tapered conical end which extends within the spark chamber towards a sample position. Preferably, the elongated electrode has a conical tip. The elongated electrode has an axis, herein referred to as the electrode axis, the axis extending generally along the direction of elongation and the electrode is oriented within the spark chamber so that the axis is directed towards the sample position. The electrode axis is preferably located substantially radially centrally in the spark chamber. In a preferred embodiment, the electrode axis also defines an axial direction of the spark chamber, with the gas flowing in a generally radial direction from the first (inlet) gas conduit on a first side of the spark chamber to the second (outlet) gas conduit on a second side of the spark chamber (opposite the first side). Although the spark chamber internal shape and components may be such that turbulence of the gas flow during spark operation is substantially eliminated, for instance as described in WO 2012/028484, which is preferred for analytical performance, the auxiliary gas flow that is provided according to the present disclosure following spark operation can create turbulences that ultimately result in better removal of ablated dust and debris from the chamber.

The spark stand may be configured to mount a solid (electrically conductive), typically metallic, sample for analysis, typically so that the sample presents a surface of the sample facing the end of the electrode in the spark chamber and/or typically such that the sample lies over an aperture in the spark stand or spark chamber wall facing the end of the electrode, usually with a gas-tight seal. The spark stand typically comprises a table that covers the spark chamber, wherein the table has an aperture that is positioned over the spark chamber. The table may receive the sample such that the sample covers the aperture and thereby presents a surface to the electrode, which surface can be analysed. A controller may be provided, which controls a high voltage source to cause one or more, typically a sequence of, electrical discharges between the electrode and the sample during a spark operation, in which the electrode functions as an anode and the sample functions as a cathode. A gas, preferably an inert gas, e.g. argon, is fed into the spark chamber via the first gas conduit during the spark operation and analysis.

According to another aspect of the present disclosure there is provided an optical emission spectrometer (OES) comprising the spark stand. The optical emission spectrometer may further comprise an optical analyser for analysing and detecting light from the spark chamber according to its wavelengths. For example, the optical emission spectrometer may comprise a spectrograph for separating the light by its wavelengths and detecting the separated light. The light is emitted by excited sample material in the spark chamber that has been vaporised and excited by the spark operation. In this way, a spectrum of the emitted light, i.e. a series of emission lines, can be obtained that enables the composition of the sample material to be deduced. The spark stand and the optical emission spectrometer can be used for performing optical emission spectrometry.

According to a further aspect of the present disclosure there is provided a method of optical emission spectrometry, comprising: providing an auxiliary gas flow into a spark chamber via at least one auxiliary gas conduit configured to provide the auxiliary gas flow into the spark chamber after spark operation but not during spark operation. The method may be carried out using the spark stand or optical emission spectrometer of the present disclosure. The method of the present disclosure embodies functions of the spark stand and its components. The features of the spark stand and optical emission spectrometer apply mutatis mutandis to the method.

In some embodiments, the method comprises providing a first gas flow into the spark chamber during spark operation, for example via a first gas conduit, which is separate to the auxiliary gas conduit(s). The first gas flow thus may flow through the spark chamber during spark operation, i.e. over the course of a sequence of sparks applied to a sample in the spark chamber during which light emission from the spark chamber is analysed. The first gas flow may be laminar gas flow. In some embodiments, the method comprises carrying gas from the spark chamber during and after spark operation via a second gas conduit, for example to an exhaust or recycling line.

In some embodiments, the first gas flow into the spark chamber is provided after spark operation additionally to during spark operation such that the auxiliary gas flow combines with the first gas flow after spark operation. The first gas flow rate may also be increased after spark operation for the removal of dust. The auxiliary gas flow may be provided in a crossed flow configuration with the first gas flow. In some embodiments, the first gas flow is laminar flow. In some embodiments, the first gas flow is laminar flow during spark operation and the laminar flow is interrupted by the auxiliary gas flow after spark operation. This crossed flow may create turbulences and vortices, which, in turn, stir up accumulated dust, resulting in better dust removal and reduced dust growth.

The method of the present disclosure may comprise other, well known steps of optical emission spectrometry, such as any of the following: providing a solid (typically metallic) sample for analysis, typically which is mounted such that it presents a surface of the sample to the end of an electrode in the spark chamber and/or typically such that it lies over an aperture in the spark chamber wall facing the end of the electrode, usually with an air-tight seal; causing one or more, typically a sequence of, electrical discharges between the electrode and the sample during a spark operation, in which the sample acts as a cathode; ablating and atomising material from the sample and exciting at least a proportion of the vaporised material whereby the excited material emits photons, the energies of which are characteristic of the elements in the material;

and performing spectroscopic analysis of the emitted photons to thereby enable the composition of the sample material to be deduced; wherein a gas, preferably an inert gas, e.g. argon, is fed into the chamber via the gas inlet during the analysis.

The present disclosure can enable better removal of debris and dust from the spark chamber, reduced deposition of ablated material, such as metallic dusts for example, onto surfaces within the spark stand. The present disclosure further enables reduced metallic dust accumulation; stabilised analytical performance of the spectrometer over long operation periods and decreased costs associated with preventive maintenance, such as cleaning of the spark stand or replacement of parts.

Further details of the disclosure will now be described by way of examples and with reference to the Figures.

### LIST OF FIGURES

FIG. 1 shows an embodiment of a spark stand for OES analysis having a gas flow.

FIG. 2 shows a section of a spark stand for OES analysis according to an embodiment of the present disclosure.

FIG. 3 shows the gas flow rates into the spark chamber as a function of time for a spark operation with a pre- and post-spark flush operation.

FIG. 4 shows a section of a spark stand for OES analysis according to a further embodiment of the present disclosure.

FIG. 5 shows a section of a spark stand for OES analysis according to another embodiment of the present disclosure.

FIG. 6 shows schematically an OES spectrometer comprising a spark stand according to the present disclosure.

### DETAILED DESCRIPTION

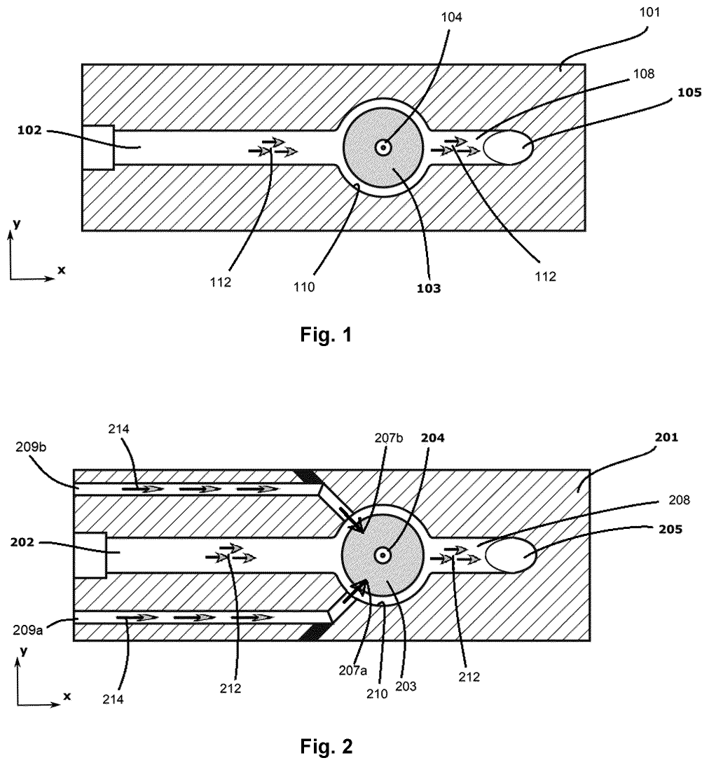

FIG. 1 shows a top sectional view of a spark stand 101 that forms part of an optical emission spectrometer. The spark stand comprises a spark chamber 110 of generally cylindrical geometry, i.e. having a cylindrical chamber wall. The spark chamber houses a cylindrical electrode 104, which is centrally located in the spark chamber and surrounded by an insulator 103 to prevent discharges to the chamber wall. Insulator 103 is rotationally symmetric about the electrode 104. The view of the spark stand 1 has been cut away from other parts of the optical emission spectrometer. For example, an optical system, such as a spectrograph, that receives light emission from the spark chamber is not shown.

In operation, a spark or discharge is ignited between the electrode 104 located in the spark chamber and the surface of a conductive sample (not shown) presented to the spark chamber. This spark operation generates a plasma which ablates, atomises and excites matter from the sample, followed light emission. The light is analysed by the optical system (not shown) to determine information about the composition of the sample from qualitative and quantitative spectroscopy. Typically, a spark operation comprises a timed sequence of sparks and the light emitted as a result of each spark is analysed.

The spark ignition takes place under an inert gas atmosphere, such as an argon (Ar) atmosphere, which is provided by a flow of (argon) gas into the spark chamber 110 through a first gas conduit 102. The gas conduit 102 is fed from a gas source upstream (not shown). The gas flows in the direction indicated by arrows 112. For example, argon gas of purity better than 99.997% may be fed into the spark chamber via the gas conduit 102 at a rate of 5 L/min (such as argon 48 grade, 99.998%) (standard litres per minute) during sample analysis. An amount of ablated matter is carried from the spark chamber by the gas flow and out through a second gas conduit 108 to an exhaust pipe 105. The gas conduits 102 and 108 lie on opposing sides of the spark chamber 110. The gas conduits can be provided by channels formed in the spark stand 101.

Once the spark or arc sequence is terminated, an amount of ablated material tends to remain in the chamber (as metallic vapor, or dust or metallic deposits). It is thought that part of the material may remain as metallic vapor or dust, whilst part of the atomised metallic dust may recombine, precipitate, deposit and/or partly metallize over the insulating area 103 surrounding the central electrode 104 and/or on the walls of the chamber 110 and/or on the tip of the electrode. Over multiple cycles of analysis, i.e. many sparks, such adhered ablated matter on the insulator 103 and the spark chamber 110 can cause performance degradation and requires regular maintenance by cleaning of the insulator 103, spark chamber 110 or other parts of the spark stand 101.

One approach to prevent dust from accumulating over several analysis cycles is to use a strong gaseous flush sequence that takes place at the end of each spark/arc sequence and/or at the beginning of each spark/arc sequence. The direction of the gas flush is also represented by arrows 112. Typically, the flow rate during such flush is increased many times with respect to the flow rate during spark/arc operation. Due to the geometrical configuration of the spark chamber, the gas passing through the conduit 102 and chamber 110 remains substantially laminar. Whilst this (laminar) flow is advantageous when operating the spark/arc sequence and performing analysis as it reduces plasma oscillations, it is not very efficient for dust removal once the spark/arc sequence is finished. The accumulation of dust deposits causes performance degradation and requires, in the best case, time-intensive manual maintenance. In the worst case, it requires regular substitution of several spark components, which adds to the maintenance costs of the instrument.

In FIG. 2 is shown an embodiment that improves dust removal and so improves maintenance and reduces operational costs of an optical emission spectrometer. The spark stand 201 has many of the same components as spark stand 101, including spark chamber 210, electrode 204, insulator 203, first gas conduit 202 carrying first gas flow 212, second gas conduit 208 and exhaust pipe 205. The spark stand 201 differs from the spark stand 101 in that it comprises two additional gas flow pipes 209a, 209b, which function as auxiliary gas conduits. The gas flow pipes 209a, 209b carry the same gas as the first gas conduit 202, such as argon. However, in other embodiments, the flow pipes 209a, 209b could carry a different, inert gas for flushing the chamber. Considering the electrode 204 to be oriented in the longitudinal direction (out of the page of the figure), the gas flow pipes 209a, 209b are positioned laterally on either side of, and at the same distance from, the first gas conduit 202. Each of the flow pipes 209a, 209b is connected to a valve (not shown) that allows gas flow for flushing when open and stops the gas flow when closed. In some embodiments, each pipe may be connected to a respective valve, or both pipes may be connected to a common valve. The valve(s) can be a solenoid valve, gate valve, needle valve or any other suitable type of gas valve.

During spark operation and analysis of light emission, the valve is closed to prevent gas flow into the spark chamber through the gas flow pipes 209a, 209b. Thus, the gas flow into the spark chamber 210 during spark operation is provided by the first conduit 202 as shown by arrows 212 and is preferably a laminar flow dictated by the geometry of the chamber 210 and the positions of the first and second gas conduits 202 and 208.

After spark operation and analysis is complete, a flushing operation can be initiated for a period in order to remove dust from the chamber created by the ablation of solid material during spark operation. For such operation, the valves are switched to open, thus allowing gas 214 to flow through the flow pipes 209a, 209b and into the spark chamber as two auxiliary argon gas flows 207a, 207b that cross with and superimpose with the central argon gas flow 212 through first conduit 202. The outlets of flow pipes 209a, 209b are oriented to direct the auxiliary gas flows 207a, 207b generally towards the centre of the spark chamber, i.e. in the vicinity of the spark electrode 204. Thus, two peripheral auxiliary gas flows 207a, 207b cross or intersect a central, first gas flow 212.

The flow rate of the auxiliary argon gas flows 207a, 207b is preferably greater than the flow rate through the first gas conduit 202 during spark operation/analysis. In this embodiment, the first gas flow rate through the first gas conduit 202 during spark operation and sample analysis may be in the range 2 to 5 L/minute or 3 to 5 L/minute. For the flushing operation, the gas flow rate of the central gas flow through the first gas conduit 202 is increased. For example, the gas flow rate through the first gas conduit 202 is increased by 2 to 10 times or by 2 to 5 times, for instance to 15 L/min, during the flushing operation. However, in other embodiments, other flow rates may be selected that are more suitable to the particular system. At the same time, for the flushing operation, the valves on the auxiliary gas conduits 209a, 209b are opened to allow the auxiliary gas flows 207a, 207b into the spark chamber, which have a similar gas flow rate to the increased central gas flow rate through the first gas conduit 202, for example 15 L/minute. The given flow rate of the auxiliary gas flows is the sum of the flow rates through the two auxiliary gas conduits 209a, 209b. Thus, the flushing operation comprises a total flow rate though the chamber of 30 L/min made up of a flow rate of 15 L/min for gas flow 212 and a flow rate of 15 L/min for the sum of auxiliary gas flows 214. The pressure or velocity of the auxiliary gas flow 214 is also dependent on the diameter of the auxiliary gas conduits 209a, 209b. For the aforementioned gas flow rates, a suitable internal diameter for the auxiliary gas conduits 209a, 209b may be 0.5 to 5 mm, which achieves a gas pressure or velocity into the spark chamber sufficient for flushing.

The fast, crossed-flow configuration of the auxiliary gas flows allows a laminar flow to be broken in the region surrounding the electrode 204 and the insulator 203, creating turbulences in the flow. Such turbulences are thought to create unsteady vortices, which interact with each other and, consequently, increase the drag due to friction effects and pressure variations. This has been found to result in better exhaust dust removal from the spark chamber, reduced dust growth and improved maintenance conditions overall.

After flushing is completed, the auxiliary flow pipes 209a, 209b are closed again by closing their valves. In some embodiments, the flushing operation can be performed at the end of each spark/arc sequence but, in other embodiments, the flushing operation can be performed less frequently, e.g. after a certain number of spark/arc sequences. A typical flushing operation can last from a few tenths of a second to a few seconds. The period for flushing may be, for example, from 1 to 5 seconds, such as about 2 or 3 seconds. However, in some embodiments, the period for flushing may be shorter or longer than this range. The auxiliary gas flow, and where applicable the first gas flow, may be a continuous flow during the period or, more preferably, may comprise a sequence of short gas pulses to aid dust removal. For example, each short gas burst may last less than 1 second, such as a few tenths of a second, or less than a tenth of a second. This period for flushing contrasts with the duration of a typical spark operation or analysis phase that may last, for example, from 10 to 25 s and which is typically made up of 2 to 3 phases in which each phase comprises 4 to 8 seconds of sparks (so that the total sparking operation is, e.g., between 10 to 25 s).

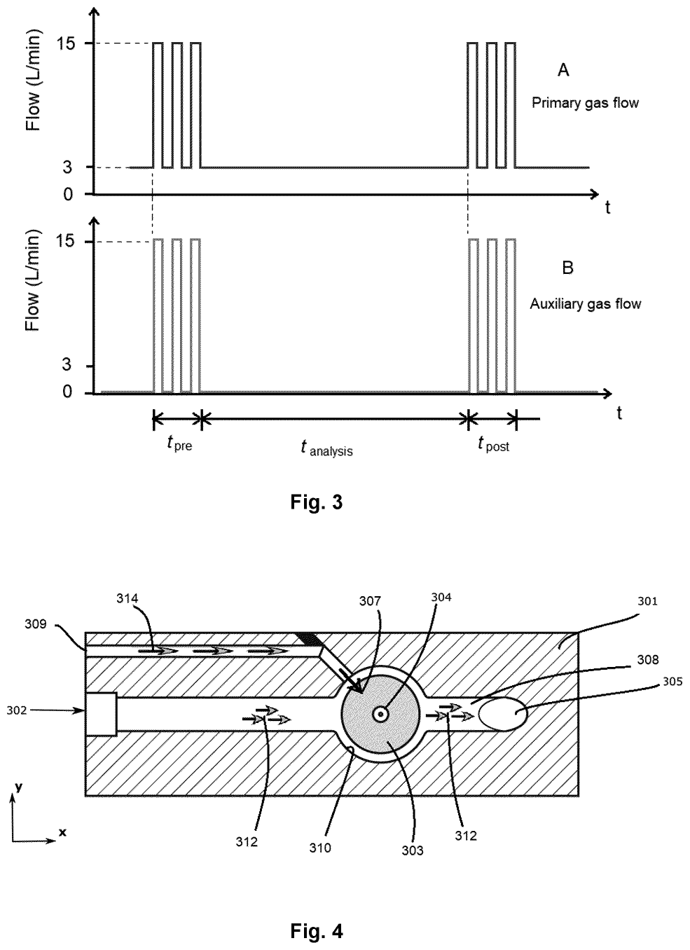

The flushing operation for removing dust from the spark chamber by means of the auxiliary gas flow may be implemented after each spark operation and before each spark operation. Thus, there can be two flushing periods between each spark operation or analysis period. This sequence is shown schematically in FIG. 3, which illustrates gas flow rates into the spark chamber as a function of time for a spark operation with a pre- and post-spark flush operation. The upper trace (A) shows the gas flow rate for the first gas flow 212 over time. The first gas flow 212 is maintained at a steady flow, in this embodiment of 3 L/min, until a first time period, tₚᵣₑ, which is a pre-analysis flushing period. During the pre-analysis flushing period, tₚᵣₑ, the flow rate of first gas flow 212 is increased in a series of gas bursts, i.e. pulses, (three bursts of 15 L/min are shown for simplicity). As shown by lower trace (B), the auxiliary gas flow is off until the pre-analysis flushing period, tₚᵣₑ, when the auxiliary gas conduits are opened to release the auxiliary gas flow 207a, 207b as a series of gas bursts (in this embodiment, of the same flow rate as the bursts of the first flow flow, i.e. 15 L/min) coincident in time with the gas bursts in the first gas flow 212. The gas bursts may be effected by rapid opening and closing of the valve(s) on the respective gas conduits. When the analysis time period, t_{analysis}, is reached, the auxiliary gas flow 207a, 207b is switched off once again and the first gas flow 212 is reduced to the steady flow of 3 L/min. Under this low and steady, laminar first gas flow, the spark operation is effected in the spark chamber during t_{analysis} and analysis of light emission is performed. At the end of the spark operation, a post-analysis flushing operation is performed during period tₚₒₛₜ. In the same way as the pre-analysis flushing, the flow rate of first gas flow 212 during post-analysis flushing is increased from 3 L/min to 15 L/min in a series of gas bursts and the auxiliary gas conduits are opened again to release the auxiliary gas flow 207a, 207b as a series of 15 L/min gas bursts. After the post-analysis flushing period tₚₒₛₜ, the auxiliary gas flow 207a, 207b is switched off once again and the first gas flow 212 is reduced to the steady flow of 3 L/min. This cycle is repeated for each analysis that is performed.

The embodiments of this disclosure advantageously can allow a controlled, for example laminar, gaseous flow through the spark chamber during spark/arc sequences by providing the gas flow through the central gas conduit 202, whilst the auxiliary gas conduits 209a, 209b are closed off by the valves. This allows the analytical conditions in the spark chamber to be stable and optimal during spark/arc sequences, which is of paramount importance for reproducible and precise analytical results. When flushing of dust is required, the controlled, for example laminar, gas flow can be interrupted by providing the auxiliary gas flow from auxiliary gas conduits 209a, 209b by opening the valves, which results in a fast, cross-flow creating turbulences that assist in removal of dust.

A further embodiment is shown in FIG. 4. The spark stand 301 has many of the same components as spark stand 201, including spark chamber 310, electrode 304, insulator 303, first gas conduit 302 carrying first gas flow 312, second gas conduit 308 and exhaust pipe 305. The spark stand 301 is fully analogous to the spark stand 201 but differs from it principally in that stand 301 comprises a single auxiliary gas flow pipe 309. The auxiliary gas flow pipe 309 is positioned laterally to the side of the first gas conduit 302. A valve (not shown) is provided upstream on the flow pipe 309 to open and close it to the auxiliary gas flow 314. When open, an auxiliary gas flow 307 is directed into the spark chamber. An advantage of the embodiment of FIG. 4 lies in the creation of turbulences both in the x, and y dimensions in the region surrounding the insulator 303 and the electrode 304. This may stir up exhaust dusts more efficiently for removal in the gas flow and thereby improve the dust removal and overall maintenance. The embodiment shown in FIG. 2, in providing two lateral auxiliary flow pipes, will result in strong turbulences in the x dimension in particular, but these will mostly cancel out in the y dimension for reasons of geometrical symmetry. Nevertheless, an advantage of the embodiment of FIG. 2 lies in providing an auxiliary flow aimed to stir up dusts and positively push them in the x dimension towards the outlet conduit 308 for removal, thus avoiding any recirculation within the spark chamber 310 and ensuring these dusts are collected through the exhaust pipe 305.

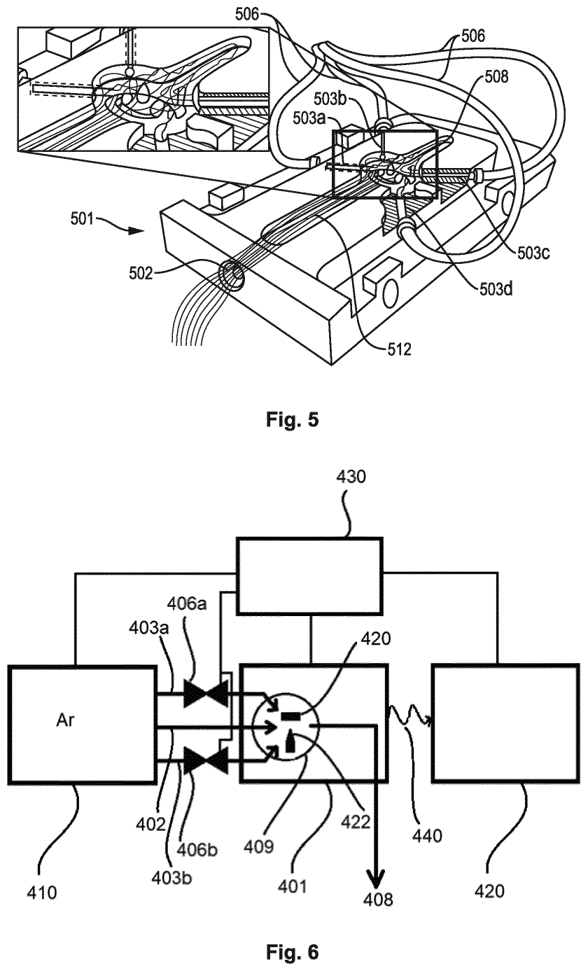

Another embodiment is shown in FIG. 5. The spark stand 501 has many of the same components as spark stand 201, including first gas conduit 502 carrying first gas flow 512, and second gas conduit 508 for collecting and removing the gas flow. The spark stand 501 is analogous to the spark stand 201 but differs from it principally in that stand 501 comprises four auxiliary gas flow pipes 503a, 503b, 503c and 503d. The four auxiliary gas flow pipes are oriented in an X or cross formation to direct their auxiliary gas flows towards the centre of the spark chamber, i.e. in the vicinity of the spark electrode. Thus, four auxiliary gas flows cross or intersect the central, first gas flow 512 inside the spark chamber to create a turbulent flow for removal of dust from the chamber.

An embodiment of an OES spectrometer comprising the spark stand of the present disclosure is shown schematically in FIG. 6. The spark stand 401 comprises a spark chamber 409 in which is housed a spark electrode 422 that faces a sample 420 that is to be analysed. A controller 430 comprising a computer or other processor and associated control electronics for controlling a high voltage discharge is connected to the spark stand for initiating high voltage spark/arc discharges between the electrode and the sample. During spark operation and analysis of the sample, light 440 emitted from the spark chamber is collected and detected by optical analyser 420, such as a spectrograph. Detection signals from the optical analyser 420 are sent to the controller 430 for storage and processing by the computer or other processor to generate emission data (e.g. spectra or light intensities at specific wavelengths) and determine information about the composition of the sample. The controller 430 further controls a source of argon gas 410 which feeds the gas into the spark chamber via a first, central gas conduit 402. The gas flows through the chamber and is carried away by a second gas conduit to an exhaust line 408. The argon flow is provided by central gas conduit 402 through the spark chamber during spark operation. After spark operation, the controller 430 initiates a flushing operation in which it opens valves 406a and 406b on auxiliary gas lines 403a and 403b respectively, which were previously closed during spark operation. The auxiliary gas lines 403a and 403b provide a fast (preferably pulsed), crossed flow of argon gas that crosses the central flow from conduit 402 in the spark chamber and stirs dust in the chamber to aid its removal to the exhaust 408. After flushing with argon from the auxiliary gas lines 403a and 403b, the controller closes the valves 406a and 406b again in preparation for the next spark operation and sample analysis. A further flushing operation may also be performed immediately before the next spark operation and sample analysis.

It will be appreciated that variations to the foregoing embodiments of the disclosure can be made while still falling within the scope of the disclosure.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

As used herein, including in the claims, unless the context indicates otherwise, singular forms of the terms herein are to be construed as including the plural form and vice versa. For instance, unless the context indicates otherwise, a singular reference herein including in the claims, such as “a” or “an” means “one or more”.

Throughout the description and claims of this specification, the words “comprise”, “including”, “having” and “contain” and variations of the words, for example “comprising” and “comprises” etc, mean “including but not limited to”, and are not intended to (and do not) exclude other components.

1. A spark stand for an optical emission spectrometer, comprising:
a spark chamber; and
at least one auxiliary gas conduit for providing an auxiliary gas flow into the spark chamber, wherein the at least one auxiliary gas conduit is configured to provide the auxiliary gas flow into the spark chamber for a period after spark operation but not during spark operation.

2. A spark stand according to claim 1, wherein the at least one auxiliary gas conduit is a single auxiliary gas conduit.

3. A spark stand according to claim 1, wherein the at least one auxiliary gas conduit is two or more auxiliary gas conduits.

4. A spark stand according to claim 1, wherein the at least one auxiliary gas conduit is switchable between an open position and a closed position.

5. A spark stand according to claim 4, wherein the at least one auxiliary gas conduit comprises at least one valve to open or close the at least one auxiliary gas conduit and thereby allow or prevent the auxiliary gas flow into the spark chamber.

6. A spark stand according to claim 1, further comprising:
a first gas conduit for providing a first gas flow into the spark chamber at least during spark operation; and
a second gas conduit for carrying gas from the spark chamber.

7. A spark stand according to claim 6, wherein the first gas conduit is for providing the first gas flow into the spark chamber after spark operation additionally to during spark operation such that the auxiliary gas flow combines with the first gas flow after spark operation.

8. A spark stand according to claim 7, wherein the at least one auxiliary gas conduit is configured to provide the auxiliary gas flow in a crossed flow configuration with the first gas flow.

9. A spark stand according to claim 8, wherein the crossed flow configuration enables generation of gas turbulences in the spark chamber.

10. A spark stand according to claim 9, wherein the first gas flow is laminar flow during spark operation and the laminar flow is broken by the auxiliary gas flow after spark operation.

11. A spark stand according to claim 10, wherein a flow rate of the auxiliary gas flow is greater than a flow rate of the first gas flow during spark operation.

12. A spark stand according to claim 11, wherein the at least one auxiliary gas conduit is two auxiliary gas conduits, the two auxiliary gas conduits being positioned symmetrically on either side of the first gas conduit.

13. A spark stand according to claim 12, wherein the auxiliary gas flow comprises a series of gas pulses.

14. An optical emission spectrometer comprising the spark stand of claim 1.

15. A method of optical emission spectrometry, comprising:
providing an auxiliary gas flow into a spark chamber via at least one auxiliary gas conduit configured to provide the auxiliary gas flow into the spark chamber for a period after spark operation but not during spark operation.

16. A spark stand according to claim 5, wherein the at least one auxiliary gas conduit is switchable between an open position and a closed position.

17. A spark stand according to claim 8, wherein the first gas flow is laminar flow during spark operation and the laminar flow is broken by the auxiliary gas flow after spark operation.

18. A spark stand according to claim 6, wherein a flow rate of the auxiliary gas flow is greater than a flow rate of the first gas flow during spark operation.

19. A spark stand according to claim 6, wherein the at least one auxiliary gas conduit is two auxiliary gas conduits, the two auxiliary gas conduits being positioned symmetrically on either side of the first gas conduit.

20. A spark stand according to claim 1, wherein the auxiliary gas flow comprises a series of gas pulses.
